(19) United States
(12) Patent Application Publication
(10) Pub. No.: US 2010/0274568 A1
(43) Pub. Date: Oct. 28, 2010

(54) METHOD AND APPARATUS FOR MONITORING USER ACTIVITY IN LINKED SERVICES

(75) Inventors: YKA HUHTALA, Helsinki (FI); Jussi Kaasinen, Espoo (FI); Riku Suomela, Espoo (FI)

Correspondence Address: DITTHAVONG MORI & STEINER, P.C., 918 Prince Street, Alexandria, VA, 22314, US

(73) Assignee: Nokia Corporation, Espoo (FI)

(21) Appl. No.: 12/428,405

(22) Filed: Apr. 22, 2009

(51) Int. Cl. G06Q 99/00; G06Q 50/00

(52) U.S. Cl. 705/1.1

(57) ABSTRACT

An approach is provided for monitoring user activity in linked services. A linked services enabler initiates monitoring of progress of a user towards achieving a goal corresponding to a service and for periodic reporting of the progress. The goal includes an activity to be completed in one or more linked services.

### BACKGROUND

Wireless (e.g., cellular) service providers and device manufacturers are continually challenged to deliver value and convenience to consumers by, for example, providing compelling network services, applications, and content. However, as the number of available services increases, a user may find it difficult to identify and select new services that may be of interest to the user. Even for a service that has been selected, the user may grow bored and become less motivated to use the service over time. As a consequence, the service providers and device manufacturers face the additional challenges of guiding users to new services, motivating users to use multiple services, and rewarding users for using multiple services.

### SOME EXEMPLARY EMBODIMENTS

Therefore, there is a need for an approach for automatically monitoring and reporting user activity performed using linked multiple services to motivate users to utilize the multiple services.

According to one embodiment, a method comprises initiating monitoring of progress of a user towards achieving a goal corresponding to a service. The goal includes an activity to be completed in one or more linked services.

According to another embodiment, an apparatus comprising at least one processor, and at least one memory including computer program code, the at least one memory and the computer program code configured to, with the at least one processor, cause the apparatus to initiate monitoring of progress of a user towards achieving a goal corresponding to a service. The goal includes an activity to be completed in one or more linked services.

According to another embodiment, an apparatus comprises means for initiating monitoring of progress of a user towards achieving a goal corresponding to a service. The goal includes an activity to be completed in one or more linked services.

According to another embodiment, a computer-readable storage medium carrying one or more sequences of one or more instructions which, when executed by one or more processors, cause an apparatus to initiate monitoring of progress of a user towards achieving a goal corresponding to a service. The goal includes an activity to be completed in one or more linked services.

According to another embodiment, a method comprises means for providing access for initiating monitoring of progress of a user towards achieving a goal corresponding to a service. The goal includes an activity to be completed in one or more linked services.

According to yet another embodiment, an apparatus comprises means for providing access for initiating monitoring of progress of a user towards achieving a goal corresponding to a service. The goal includes an activity to be completed in one or more linked services.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a communication system capable of monitoring user activity in linked services, according to an exemplary embodiment;

FIG. 2 is a diagram of components of a linked services enabler, according to an exemplary embodiment;

FIG. 3 is a flowchart of a process for invoking one or more linked services, according to an exemplary embodiment;

FIG. 4 is a flowchart of a process for installing a linked service, according to an exemplary embodiment;

FIG. 5 is a diagram depicting activity flow between linked services, according to an exemplary embodiment;

FIG. 6 is a flowchart of a process for monitoring user activity in linked services, according to an exemplary embodiment;

FIGS. 7A and 7B are diagrams of a user interface utilized in linked services, according to an exemplary embodiment;

FIG. 8 is a flowchart of a process for monitoring user activity in linked services over a communication network, according to an exemplary embodiment;

FIG. 9 is a diagram of hardware that can be used to implement an embodiment of the invention;

FIG. 10 is a diagram of a chip set that can be used to implement an embodiment of the invention; and

FIG. 11 is a diagram of a mobile station (e.g., handset) that can be used to implement an embodiment of the invention.

### DESCRIPTION OF PREFERRED EMBODIMENT

A method and apparatus for monitoring user activity in linked services are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

Although various exemplary embodiments are described with respect to linking services within a wireless network environment, it is contemplated that the approach for linking services described herein may be used within any type of communication system or network. As used herein, the term “services” refers to applications, functions, and/or content provided over a communication system or network. In addition, it is contemplated that the services may reside on a client, a server, or both.

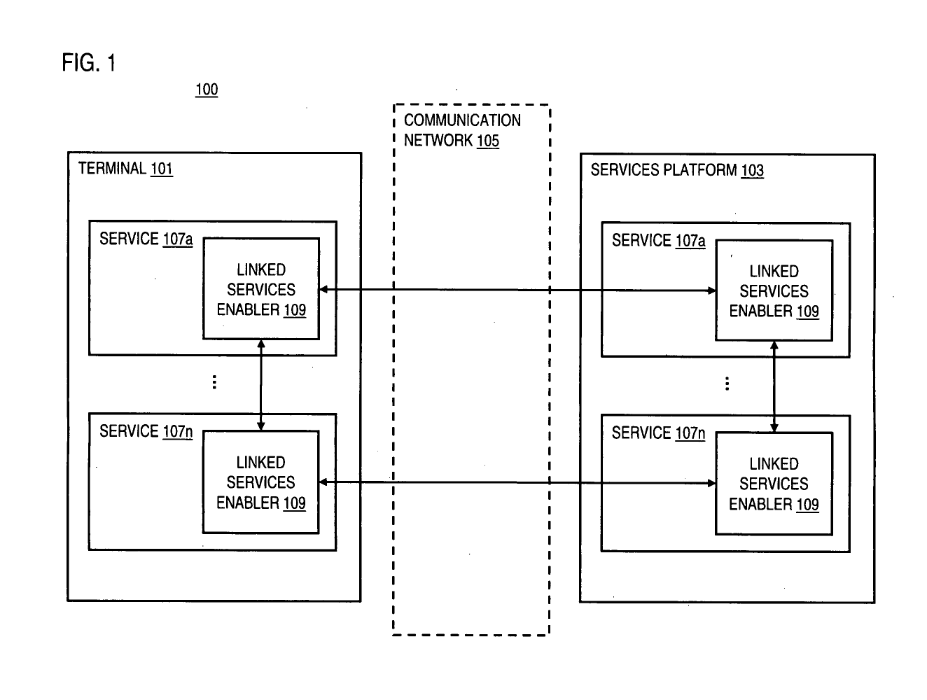

FIG. 1 is a diagram of a communication system capable of monitoring user activity in linked services, according to an exemplary embodiment. It is recognized that modern communications devices are capable of accessing a variety of services along with any corresponding applications or content, but most users traditionally tend to use only those services with which they are familiar. By seamlessly linking new services to services that are already in use, a system 100 of FIG. 1 can overcome the traditional reluctance of most users to use new services available over a communication network. More specifically, the system 100 can link services together to guide users to new services, and then motivate the users to utilize these new services by, for instance, providing rewards for completing tasks or achieving goals using the linked services. As another benefit, the linking of services advantageously reduces the number of steps for a user to discover and run new services because these services can be linked and automatically presented to the user without direct user action. Moreover, combining multiple services together results in improved technical efficiency by not requiring each service to include redundant functions already offered by another service. It is contemplated that multiple services may be linked in a way that is transparent to the user (i.e., from the user's perspective, the services appear as one coherent service). For example, a gaming service can link to a sports service for monitoring sports activity rather than have the sports activity monitoring functions built directly into the game. In exemplary embodiments, the system 100 also provides monitoring and feedback to the user on progress towards completing the tasks or achieving the goals as additional motivation to use the linked services.

As shown in FIG. 1, a system 100 comprises one or more terminals (e.g., terminal 101) having connectivity to a services platform 103 via a communication network 105. In exemplary embodiments, the terminal 101 and the services platform 103 may include one or more services 107a-107n. For example, the services 107a-107n may include a gaming service, a sports service, a mapping application, a media application, media content, a messaging application, or a combination thereof. It is also contemplated that the service 107 may include any service capable of running on the terminal 101 or the services platform 103. The system 100 enables the services 107a-107n to be linked together via a linked services enabler 109. As used herein, the term “link” or “linking” refers to sharing information among multiple services to, for instance, direct users to or integrate the applications, functions, and content associated with the multiple services. In this way, two distinct services (e.g., service 107a and 107n) may be combined and function as if they were one service. In certain embodiments, the linking of multiple services is transparent to the user, and therefore, the linked services appear as one service to the user. In addition, the services 107a-107n may also be linked together in any number of ways (e.g., service 107a within terminal 101 may be linked with service 107n within the same terminal 107, or service 107a within terminal 101 may be linked with the same service 107a within the services platform 107a).

For example, a user starts a service 107a (e.g., a gaming service). As the user advances to a particular point in the game, the service 107a gives the gives the user a task to start a linked service 107b (e.g., a messaging application). In one embodiment, a particular path in the game does not progress until the user performs the task. The user agrees to perform the task, and is presented with the option install the messaging application. The messaging application is installed, and the user accesses the messaging application to try the service and complete the task. On resuming the service 107a, the game verifies that the user has completed the task in the linked service 107b and allows the user to advance further in the game. In this way, the user is introduced to the messaging application. It is noted that the user need not perform any other task than starting the service.

In another example, the service 107a (e.g., a gaming service) invokes a linked service 107b for the user to actually perform a task in the linked service 107b in addition to just starting the linked service 107b. As in the example above, the user starts the gaming service. When the user advances to a particular point in the game, the gaming service directs the user to perform a specific task in a linked service 107b (e.g., walk one mile using a sports service, upload a photograph using a media application, or download a song from a music service). Progress in the game is limited until the user completes the task. The linked service 107b is started for the user to perform the requested task (e.g., walk one mile using a sports service, upload a photograph using a media application, or download a song from a music service). The gaming service verifies that the user has completed the task and allows the user to continue the gaming service.

In yet another example, more than two services 107a-107n can be linked. In a service 107a, the user completes a level of a game and is notified by the game that the next level happens in the real world tracked by a sports service. The game directs the user to go cycling for 10 miles using a sports service (i.e., a linked service 107b). As discussed earlier, the sports service can track the user's physical activity and automatically report the activity. To complete the task, the user goes cycling for 10 miles using the sports service and returns to the game. The game verifies that the physical activity has been completed and then directs the user to a music service (i.e., another linked service 107c) to download a free song as reward from completing the cycling task. The gaming service verifies that the user has completed the downloading of the game and allows the user to resume the game. In this way, the user is introduced to both the sports service and the music service.

FIG. 1 depicts the linked services enabler 109 as a component within each service 107. In exemplary embodiments, the linked services enabler 109 provides the components to link multiple services together. However, in certain embodiments, the linked services enabler 109 may be a standalone component that is separate from each service 107. Under this scenario, the terminal 101 and the services platform 103 include, for instance, a single linked services enabler 109 that interfaces with each service 107 resident on either the terminal 101 or the services platform 103 to support linked services.

In exemplary embodiments, the terminal 101 is any type of mobile terminal, fixed terminal, or portable terminal including mobile handsets, stations, units, devices, multimedia tablets, Internet nodes, communicators, desktop computers, laptop computers, Personal Digital Assistants (PDAs), or any combination thereof. It is also contemplated that the terminal 101 can support any type of interface to the user (such as “wearable” circuitry, etc.). In exemplary embodiments, the services platform 103 resides on the communication network 105 to provide a central server for providing services 107a-107n to the terminal 101. For example, the terminal 101 may access the services platform 103 to browse and download available services. In addition or alternatively, the terminal 101 may obtain services 107a-107n from third party service providers (not shown). It is also contemplated that terminal 101 may obtain services 107a-107n using any other suitable mechanism such as direct transfer from physical media (e.g., flash memory) or pre-loading from the factory. In certain embodiments, the services 107a-107b may be different components with a common service platform. For example the common service platform may be a gaming application that allows third parties to develop different components (e.g., game levels, musical soundtracks, video content, etc.) for use in the gaming application.

Additionally, the communication network 105 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), the Internet, or any other suitable packet-switched network, such as a commercially owned, proprietary packet-switched network, e.g., a proprietary cable or fiber-optic network. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wireless fidelity (WiFi), satellite, mobile ad-hoc network (MANET), and the like.

By way of example, the terminal 101 communicates with the services platform 103 and other terminals 101 over the communication network 105 using standard protocols. The terminals 101 and the services platform 103 are network nodes with respect to the communication network 105. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 6 and layer 7) as defined by the OSI Reference Model.

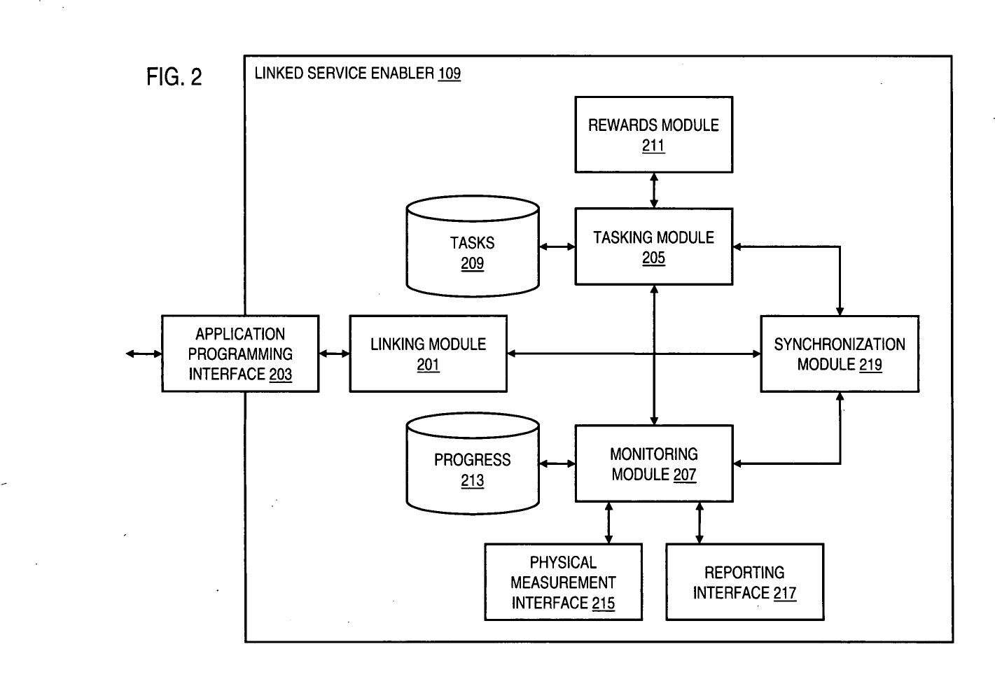

FIG. 2 is a diagram of components of a linked services enabler, according to an exemplary embodiment. By way of example, the linked services enabler 109 includes one or more components for linking together multiple services 107a-107n. It is contemplated that the functions of these components may be combined in one or more components or performed by other components of equivalent functionality. In this embodiment, the linked services enabler 109 includes a linking module 201 for coordinating the linking of multiple services 107a-107n. For example, the linking module 201 may track which services 107a-107n are linked and what information (e.g., information related to tasks and progress towards completing those tasks) are shared among the linked services 107a-107n. In addition, the linking module 201 may authenticate the linked services 107a-107n to ensure that only authorized services 107a-107n may be linked. It is contemplated that the linking module 201 may use any authentication mechanism or scheme (e.g., shared secrets, network address filtering, passkey, etc.). The linking module 201 has connectivity to the services 107a-107n through an application programming interface (API) 203. The API 203 provides, for instance, a set of routines, data structures, protocols, and/or services to support the building of applications for linked services 107a-107n using the components and functions of the linked services enabler 109.

To assist in sharing information among the linked services 107a-107n, the linking module 201 has connectivity to a tasking module 205 and a monitoring module 207. As discussed previously, linking services 107a-107n together enables a service 107a to invoke one or more linked services 107b-107n for the user to perform an action or task before resuming the service 107a or receiving a reward in the service 107a. In exemplary embodiments, the tasking module tracks the tasks or actions assigned or made available by the linked services 107a-107n as well as any corresponding rewards associated with the tasks or actions. In addition, one service 107a may push a task to another service 107b, whereby the first service 107a creates a task to present to the user of the second service 107b without the user ever actually using the first service 107a. For example, a gaming service pushes a task to run 10 km to the sports service. The user accesses the sports service and is then presented with the task to run 10 km to receive a reward in the gaming service.

It is contemplated that the tasks or actions also include goals that are achieved using the linked services 107a-107n. The tasks and corresponding rewards are stored in a database 209 of tasks. The data elements of the tasks database 209 include, for instance, a description of the task, the service 107 initiating the task, the service 107 in which the task is to be completed, and a reward associated with completion of the task. Table 1 below lists at least some of the data elements that may be included in the tasks database 209. It is contemplated that additional data elements may be added as well.

TABLE 1

| Data | |
|---|---|
| Element | Description |
| Task | Describes the task or goal created in a first service 107a |
| Description | that is to be completed in a second service 107b |
| | (e.g., run 10 km) |
| Initiating | Identifies the service 107 that initiates the task (e.g., a |
| Service | first service 107a such as a gaming service) |
| Service to | Identifies the service 107 in which the task is to be |
| Complete | completed (e.g., a second service 107b such as a |
| Task | sports service in which the 10 km run is to |
| | be completed) |
| Reward | Identifies the corresponding reward, if any, for |
| | completing the task (e.g., a gaming service rewards a user |
| | that runs 10 km in a sports service with |
| | additional gaming levels) |

Table 1 below lists examples of tasks and their corresponding rewards. As shown in Table 1, potential rewards include in-service currency (e.g., currency that can be used to buy for items, content, features, etc. in a particular service 107), reputation (e.g., a level of recognition of certain achievements or characteristics typically represented as points with a service 107), character improvement (e.g., a virtual character within a service 107 receives enhancements to a virtual character attribute such as intelligence or speed), items (e.g., virtual items that are used within a service 107), additional game levels, additional service time (e.g., additional time to use a particular service 107 when a time limit is placed on the use of the service such as when limiting time on a gaming service), user interface (UI) improvements (e.g., a new UI element that depicts distance traveled in a sports service as a gauge in addition to the standard numerical presentation), media content (e.g., movies, videos, songs), additional services (e.g., new services that are not available until the corresponding task is completed), or a combination thereof. It is contemplated that any reward (e.g., both virtual and real, i.e., actual merchandise) can be a reward within the system 100. These rewards, for instance, may motivate users to perform the assigned tasked to become more familiar with services that they might not otherwise use. Moreover, as users become more familiar with additional services, it is anticipated that they will correspondingly increase the number of services that they use on a routine based. It is also contemplated that a task need not have a corresponding reward when, for example, the aim is to merely introduce users to a particular service.

TABLE 2

| | | Example Task and |
|---|---|---|
| Reward Type | Explanation | Corresponding Reward |
| In-service | Completion of a task (e.g., physical activity | Running 1 km = 2 game |
| currency | tracked by a sports service) earns currency | credits |
| | used in a particular service. The currency | Walking 1 km = 1 game |
| | can be used to purchase items or services | credit |
| | from a service. | |
| Reputation | Reputation is typically represented as points | Uploading a photo = +3 |
| | in a service (e.g., reputation in an online | reputation points |
| | gaming service). Completion of a task | Running a marathon = +20 |
| | earns additional points to increase | reputation points |
| | reputation. | |
| Character | Some services provide a user with a virtual | Playing five songs = New |
| improvement | character (e.g., online role-playing games). | musical instruments for |
| | Completion of a task increases one or more | virtual character |
| | characteristics of the virtual character. | Cycling 10 km = +25 |
| | | increase in character health |
| | | points |
| Items | Completion of a task earns virtual items | Accessing mapping |
| | used in a service (e.g., a gaming service). | application = in-game |
| | | compass |
| Additional game | Completion of a task earns new game | Messaging five friends = |
| levels | levels. | access to hidden game level |
| Additional | Completion of a task earns additional time | Running 5 km = Receive 30 |
| service time | for using a service (e.g., when time limits | minutes of extra game time |
| | are placed on using a particular service such | Walking 10 km = Receive |
| | as a gaming service or messaging | 15 minutes of extra time in |
| | application) | a chat room |
| User Interface | Completion of a task results in a new user | Complete a car game = car |
| Improvements | interface element for viewing existing | style speedometer to |
| | service information in a new way or | measure running or cycling |
| | viewing additional service information. | speed |
| | | Cycling 200 km = new UI |
| | | for maps in a role-playing |
| | | game for displaying safe |
| | | zones |
| Media content | Completion of a task earns media content | Walking 10 miles in one |
| | (e.g., video, song). | week = music video |
| Additional | Completion of a task results in availability | Receive 200 E-mails = |
| services | of a new service. | access to a E-book service |

As further motivation to users, rewards may be assigned to tasks based on the difficulty of achieving the task. For example, more unique or more highly coveted rewards may be assigned to more difficult tasks. In this way, users may be motivated to use particular services 107a-107n even more intently. For example, in a sports service used for tracking physical activity (e.g., running, cycling, walking, etc.), more valuable rewards are given for a achieving more difficult physical activities. Table 3 below lists examples of sports service activities of increasing difficulty and their corresponding rewards. More specifically, each reward is directly proportional to the time it takes to complete a physical activity and the level of physical fitness necessary to complete the activity.

TABLE 3

| Tasked Sports Activity | Reward |
|---|---|
| Running 5 km with a heart rate under 150 beats per | 2 music downloads |
| minute | |
| Running 5 km at a higher speed than before with | 4 music downloads |
| the same heart rate, or with the same speed but | |
| lower heart rate | |
| Running 20 km at a steady pace with a heart rate | 10 music downloads |
| within a predetermined range | |
| Running 20 km at a higher speed than before with a | 15 music downloads |
| heart rate within the same predetermined range, | |
| or in the same time with a heart rate lower than | |
| before. | |

In exemplary embodiments, the tasking module 205 also has connectivity with a rewards module 211 to coordinate the assignment and triggering of rewards corresponding to particular tasks. Because of the great variety of potential rewards, the rewards module 211, for instance, can interact with the API 203 to coordinate the varying types of rewards. For example, if the reward is additional service time, the rewards module 211 can track the different permutations of available service time rewards. Examples of various service time rewards are listed in Table 4 below.

TABLE 4

| Service Time Award | Description |
|---|---|
| Linear Service Time | Service time (e.g., gaming time) is awarded in linear fashion |
| | for completed tasks (e.g., each kilometer run in a sports |
| | service corresponds directly to one minute of gaming time). |
| Linear Extra Service Time | Extra service time beyond a predetermined limit (e.g., a limit |
| | on the time a user can spend in a gaming service over a set |
| | period of time) is awarded in a linear fashion (e.g., each |
| | kilometer run in a sports service corresponds directly to one |
| | minute of extra gaming time). |
| Non Linear Service Time | Service time is awarded in a non linear fashion (e.g., for the |
| | first 30 minutes in a sports service, each kilometer run in a |
| | sports service corresponds to one minute of gaming time; for |
| | the next 30 minute period, each kilometer run corresponds to |
| | two minutes of gaming time; for the next 30 minute period, |
| | each kilometer run corresponds to four minutes of gaming |
| | time; and so on. |
| Achievement-based Service | A specific amount of service time is awarded for completing a |
| Time | task or achievement (e.g., running a marathon using a sports |
| | service corresponds to 60 minutes of gaming time). |

As shown in FIG. 2, the linking module 201 also has connectivity to the monitoring module 207 to assist in tracking the user's progress toward achieving tasks or goals stored in the tasks database 209. In exemplary embodiments, the monitoring module 207 provides real-time monitoring of user activity in linked services 107a-107n. The monitoring module 207 also provides periodic reporting of these monitored activities as they relate to achieving the tasks and goals of database 209 (e.g., providing reports on percentage completion of each task) and alerts the user and/or the linked services 107a-107n when tasks have been completed. For example, the linking module 201 stores the monitored progress of user activity in the progress database 213. Data elements stored in the progress database include the task description and progress (e.g., a percent completion or other measure of completeness).

For example, the user plays a game in a gaming service and encounters a component that requires a real world activity such as running 5 km using a sports service. The game directs the user to the sports service to complete the real world task. The monitoring module 207 monitors the user's progress towards completing the running assignment and provides periodic reports on how far the user has run to the user and the gaming service. On completing the 5 km run, the monitoring module 207 informs the gaming service.

To assist with the monitoring of activities, the monitoring module 207 interacts with a physical measurement interface 215 and a reporting interface 217. The physical measurement interface 215, for instance, provides connectivity of a variety of physical measurement accessories or sensors to monitor activities in services 107a-107n (e.g., a sports service) that involve real work activities or measurements. By way of example, the measurement accessories and sensors measure parameters including acceleration, movement, location, elevation, heart rate, orienteering support tags, galvanic skin response, conductivity, body fat, body mass, body mass index, or a combination thereof. Table 5 below describes these parameters. It is contemplated that the monitoring module may interface with any other physical measurement accessory or sensor supported by a linked service 107.

TABLE 5

| Measurement | |
|---|---|
| Parameter | Use |
| Acceleration | Used for step counting, activity intensity level, dead |
| | reckoning in location, etc. |
| Movement | Gyroscopes and other inertial sensors may be used to |
| | determine the same information as described for |
| | acceleration. |
| Location | Used for tracking the distance, speed, route, |
| | elevation, etc. of physical or sports activities. |
| Altimeter | Used to track the elevation for sports performance (e.g., |
| | climbing or running stairs). |
| Heart Rate | Used to track the heart rate during physical activity and |
| | overall fitness level. |
| Orienteering | Used instead of location to verify that a user has visited a |
| support tags | specific location using, for instance, near field |
| | communication (NFC) tags, radio-frequency |
| | identification (RFID) tags, barcodes, visual tags, and |
| | other like technologies. |
| Galvanic Skin | Used for measuring sweat and other skin-related |
| Response | responses as a measure of physical activity. |
| Body Fat | Used to measure body fat percentage and composition. |
| Body Mass | Used to measure body weight. |
| Body Mass | Used to measure body fat percentage and composition. |
| Index | |

The monitoring module 207 also interacts with the reporting interface 217 to receive progress reports directly from other linked services 107a-107n or from the user or other parties through manual input. To receive direct progress reports directly from other linked services 107a-107n, the reporting interface 217 interacts, for instance, with the API 203. For example, the reporting interface 217 may receive reports from a gaming service on how many levels the user has completed, from a music service on how many songs the user has download, or from a messaging application on how many messages the user has sent. It is contemplated that the reporting interface 217 may receive reports from any linked services 107a-107n capable of sending the reports.

In some cases, the reporting interface 217 cannot receive automated progress reports from the linked services 107a-107n because the service report does not report such reporting (e.g., the application supporting a linked service does not have automated reporting capabilities) or the task or activity is not amenable to automated reporting (e.g., a physical activity for which there currently is no practical or readily available sensor such as swimming). In this case, the reporting interface 217 enables the user to manually enter the user's progress with respect to a particular activity. In addition or alternatively, the reporting interface 217 can receive manual progress reports from an authenticated third party (e.g., a coach or sporting official). For example, the authenticated third party is an observer of the user's sports activity who can file official progress reports. It is contemplated that the reporting interface 217 may use any authentication mechanism to verify that the third party is suitable for filing reports of the user's progress. For example, it can be difficult or unpractical to construct automated sensors to verify that a user is playing a soccer match. In this case, the user's soccer coach can enter and verify information with respect to the user's participation in a soccer match.

As shown in FIG. 2, the tasking module 205 and the monitoring module 207 are linked via a synchronization module 219. In exemplary embodiments, the synchronization module 219 initiates synchronization of information related to tasks and their progress between the tasking module 205 and monitoring module 207. For example, the synchronization of the task descriptions between the tasks database 209 and the progress database 213 enables the monitoring module to learn of tasks that have been established across the linked services 107a-107n. In this way, the monitoring module 207 can begin monitoring user activity against tasks even in cases where the user is not yet aware of an available task. It is contemplated that the synchronization module 219 may synchronize tasks and progress within the same service 107, between two different services 107a-107n within the same terminal, between the same service 107a in the terminal 101 and the services platform 103, between the two different services 107a-107n between the terminal 101 and the services platform 103, or any combination thereof.

The synchronization module 219 also can assist the monitoring module 207 to track which completed activity can be used to satisfy which particular tasks. By way of example, multiple services 107a-107n may request the user to perform the same task to receive different rewards from the respective services 107a-107n. For example, a music service may set a task for the user to run 5 km to receive a free song download. At the same time, a gaming service may set the task of running 5 km to advance to a next level. The synchronization module 219 synchronizes the tasks from the tasks database 209 to the progress database 213 to inform the monitoring module 207 that completion (or partial completion, depending on the criteria defined by the initiating service 107) a particular task can satisfy more than one service 107. In certain embodiments, the monitoring module tracks the number of times that a particular completed task has been used to receive a reward. In some cases, one or more of the services 107a-107n can limit the number of times one completed task can be used to receive a reward or satisfy goals or challenges. In this way, the monitoring module can prevent the user from performing only one action to satisfy reward requirements from multiple services 107a-107n.

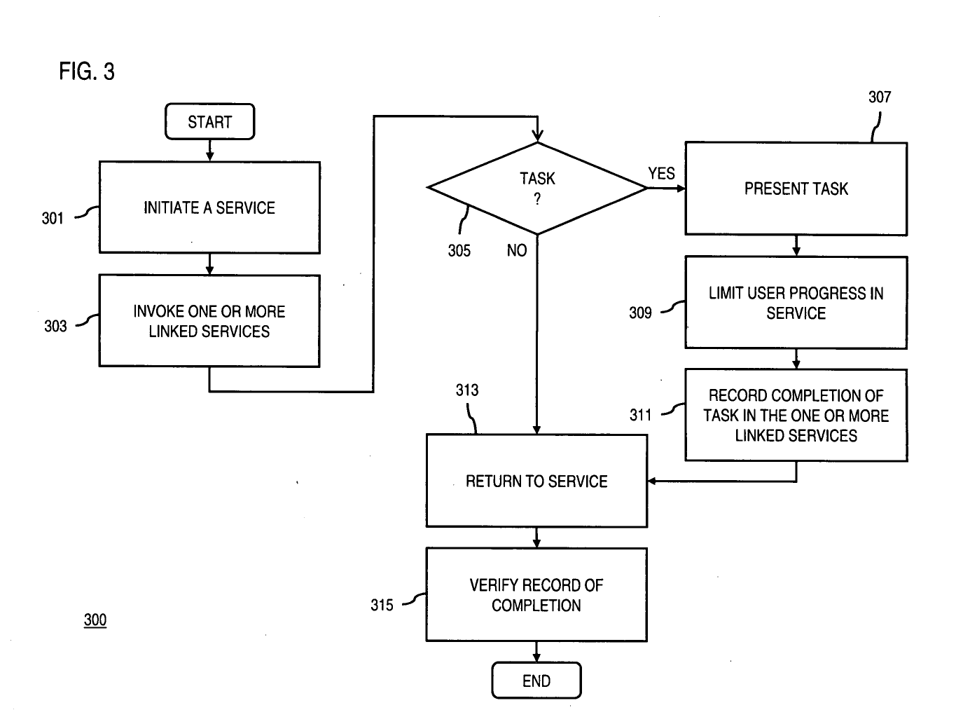

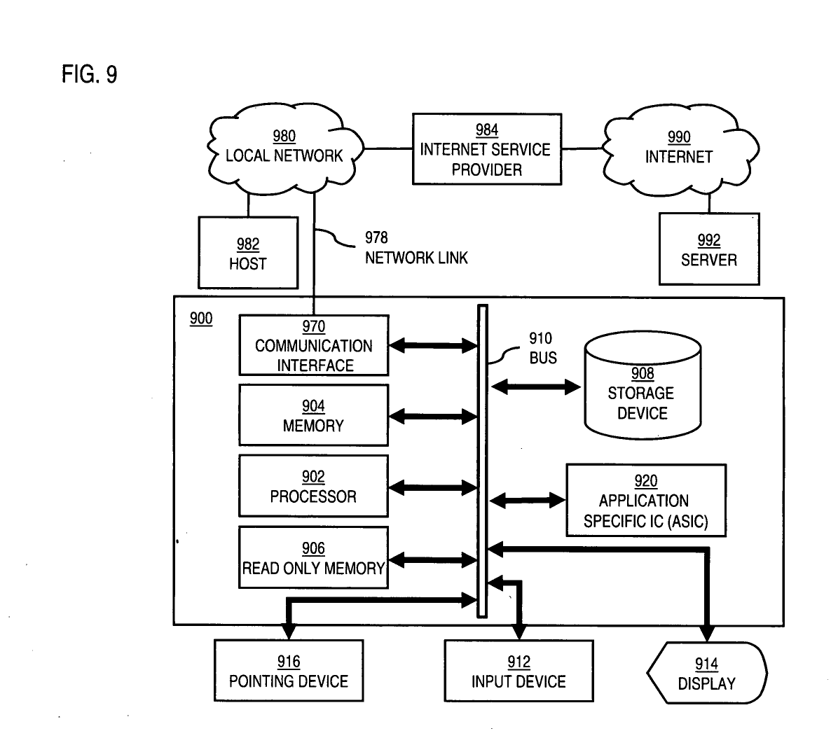

FIG. 3 is a flowchart of a process for linking services, according to an exemplary embodiment. In one embodiment, the linked services enabler 109 performs the process 300 and is implemented in, for instance, a chip set including a processor and a memory as shown in FIG. 9. In step 301, the linked services enabler 109 initiates a service 107a. In exemplary embodiments, the initiation of the service may be at the command of the user. For example, the user selects the service 107a to run on the user's terminal. In addition or alternatively, the linked services enabler 109 may initiate the service 107a to, for instance, push a task to another linked service 107b. In the case of pushing a task to another service, the user need not control or be aware of the initiation of the service. The linked services enabler 109 then invokes one or more linked services 107b-107n for the user to perform an action associated with the one or more linked services 107b-107n (step 303).

In exemplary embodiments, the action can be to just start the one or more linked services 107b-107n without performing another task. As discussed previously, directing a user to start one or more linked services 107b-107n is a mechanism for introducing or guiding a user to linked services 107b-107n the user might not otherwise try. In other cases, the action may include performing a task within the one or more linked services 107b-107n. If the action includes a task (step 305), the linked services enabler 109 presents the task to the user to complete in the one or more linked services 107b-107n (step 307). To present the task, the linked services enabler 109 in the one or more linked services 107b-107n, for instance, displays the task and requests user confirmation to perform the task. For example, a gaming service may direct the user to download a song from music store as part of completing a game in the gaming service. As part of an initial setup for linking the service 107a and the one or more other services 107b-107n, the linked services enabler 109 within each respective service will have exchanged information related to the assigned task to synchronize the task across the linked services 107a-107n.

In certain embodiments, the linked services enabler 109 in the service 107a may optionally limit the progress of the user in the service 107a until the user completes the task in the one or more linked services 107b-107n (step 309). If the goal is to merely introduce the user to the one or more linked services 107b-107n, performance of the task need not be mandatory and progress in the service 107a is not limited. However, by limiting progress in the service 107a, the user can be encouraged to complete the task in the one or more linked services 107b-107n. In this way, the user is encouraged not only to start the one or more linked services 107b-107n, but to also use the one or more linked services 107b-107n to perform a task. The user can then become more familiar with the one or more linked services 107b-107n which makes the user more likely to use the one or more linked services 107b-107n on a routine basis. Once, the user completes task, the linked services enabler 109 in the one or more linked services 107b-107n optionally records completion of the task (step 311). If verification of the completion of the task is not needed or required, then step 311 can be skipped.

The linked services enabler 109 of the service 107a then returns the user to the service 107b (step 313). Optionally, the linked services enabler 109 can verify the completion of the task before returning to the service 107a (step 315). For instance, the linked services enabler 109 verifies with the one or more linked services 107b-107n that the task has been completed.

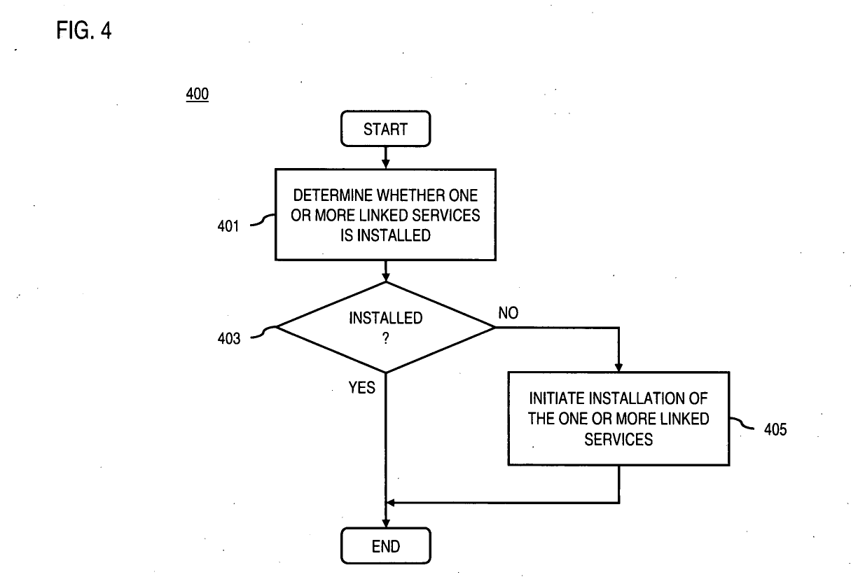

FIG. 4 is a flowchart of a process for installing a linked service, according to an exemplary embodiment. In one embodiment, the linked services enabler 109 performs the process 400 and is implemented in, for instance, a chip set including a processor and a memory as shown in FIG. 9. It is anticipated that many of the linked services 107a-107n will be new to a particular (i.e., the user will not have tried one of the linked services 107a-107n in the past). As a result, the user's terminal 101 may not have one or more of the linked services installed. In step 401, on directing a user to one or more linked services 107b-107n, the linked services enabler 109 determines whether the one or more linked services 107b-107n is installed on the user's terminal 101 or otherwise made available (e.g., through the services platform 103). Based on the determination (step 403), if the one or more linked services 107b-107n is not installed on the user's terminal 101, the linked services enabler 109 initiates installation of the one or more linked services 107b-107n (step 405). For example, the terminal 101 may be directed to download and install the one or more linked services 107b-107n from the services platform 103. It is contemplated that the terminal 101 may use any mechanism to receive the applications and/or content associated with the one or more linked services 107b-107n (e.g., direct loading from a removable flash memory). On installation, the linked services enabler 109 can continue with the process as described with respect to FIG. 2.

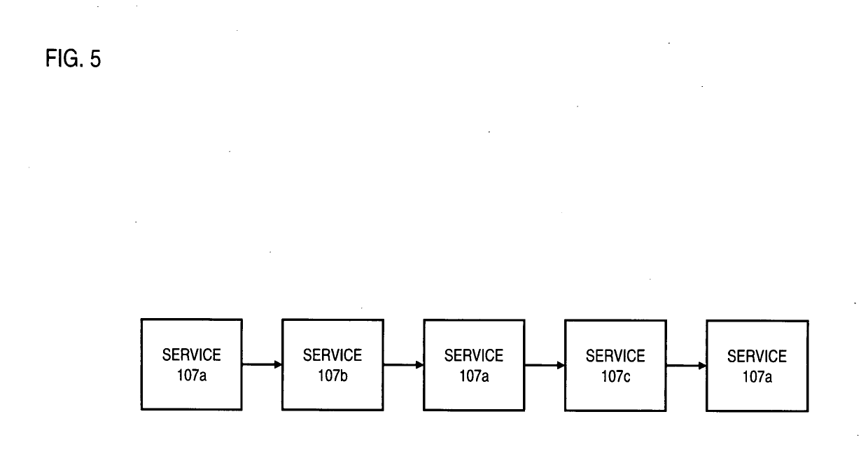

FIG. 5 is a diagram depicting activity flow between linked services, according to an exemplary embodiment. By linking services as described herein with respect to system 100, one or more distinct services 107a-107b are combined in a seamless way to provide the appearance to the user of a single coherent service. As shown in FIG. 5, the linked services enabler 109 seamlessly directs user activity and control from one service 107 to the next. For example, the user initiates a service 107a (e.g., a gaming service), the gaming service 107a includes as one of its levels a requirement to run 10 km. The gaming service 107a then directs the user to the sports service 107b to perform the task of running 10 km. The run is performed under the sports service 107b to enable automated tracking and reporting of the user's completion of the run. After completing the run, the user resumes the gaming service 107a which then directs the user to a music service 107c to download a song. After downloading the song, the service 107c directs the user back to the gaming service 107a where the user can resume the gaming session.

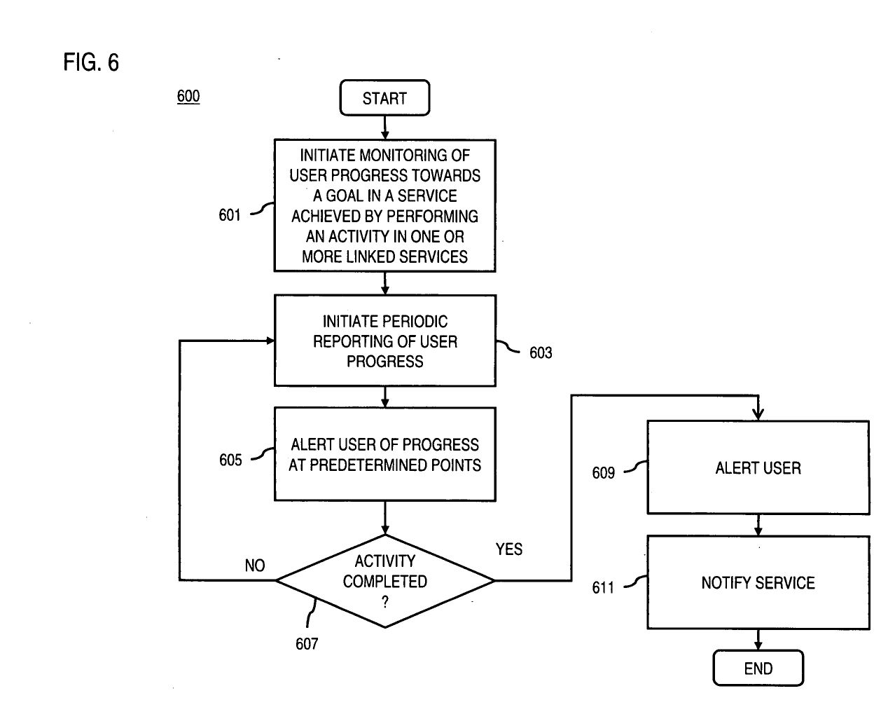

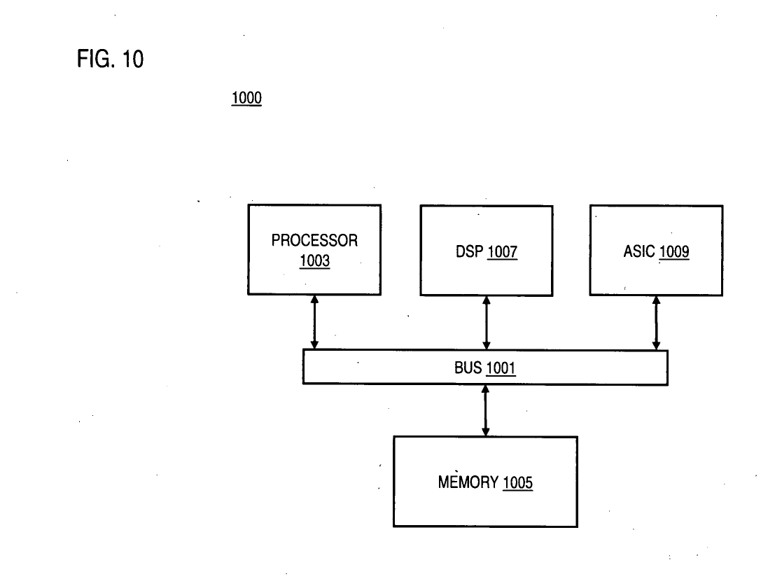

FIG. 6 is a flowchart of a process for monitoring user activity in linked services, according to an exemplary embodiment. In one embodiment, the linked services enabler 109 performs the process 400 and is implemented in, for instance, a chip set including a processor and a memory as shown in FIG. 10. In step 601, the linked services enabler 109 initiates monitoring of a user's progress towards achieving a goal (e.g., a task or action) corresponding to a service 107a (e.g., a gaming service, sports service). In exemplary embodiments, the goal may include, for instance, an activity (e.g., a task or action) that is to be completed in one or more linked services 107b-107n or that is otherwise related to the one or more linked services 107b-107n.

In exemplary embodiments, the specific mode of monitoring is dependent on the nature of service 107 in which the activity is to be completed. For example, to monitor user activity in a sports service, the linked services enabler 109 may use physical measurement accessories as described with respect FIG. 2. In this way, progress related to sports activities such as running, walking, or cycling can be monitored through, for instance, empirical measurements of distance using location or movement sensors. In other services 107 (e.g., a gaming service), the service 107 may have built-in information to report the user's progress. For example, a gaming service typically already tracks the level or score achieved by the user; this level or score can be reported to the linked services enabler 109 as a measure of user progress. In some cases, automated monitoring is not possible or practical (e.g., a user engaged in a swimming activity where a sensor may not be practical). Accordingly, the linked services enabler 109 may monitor these activities through user reporting or reporting by authenticated third parties as described with respect to FIG. 2.

After monitoring is initiated, the linked services enabler 109 initiates periodic reporting of the user's progress (step 603). It is contemplated that the user's progress may be reported to the user, the service 107a, the one or more linked services 107b-107n, or any combination thereof. In addition, the reporting frequency may also be set by the user, the service 107a, the one or more linked services 107b-107n, or any combination thereof. By way of example, the periodic report at least identifies the activity and a measure of the user's progress towards completing the activity (e.g., a percent completion, distance traveled, number of game levels completed, number of songs downloaded, etc.). The report may also include related parameters or statistics (e.g., a progress report on a 10 km run may also include the heart rate of the user and/or speed; a progress report on a gaming activity may include time spent playing the game, number or restarts, etc.). In exemplary embodiments, the content of the report is configurable and may be specified by the linked services 107a-107n using, for instance, the API 203 of the linked services enabler 109.

In addition to the periodic reports, the linked services enabler 109 can alert the user when the level of progress reaches a predetermined point (e.g., 50% completion, 10 game levels completed, etc.) (step 605). The predetermined points may, for instance, be configured by the user, the service 107a, the one or more linked services 107b, or any combination thereof. In exemplary embodiments, the linked services enabler 109 monitors the user's activity and provides periodic reports and alerts until the activity is completed by the user (step 607). If the activity is completed and the goal is achieved, the linked services enabler 109 alerts the user that the activity is completed (step 609) and notifies the service 107a that the user has completed the activity to achieve the goal (step 611).

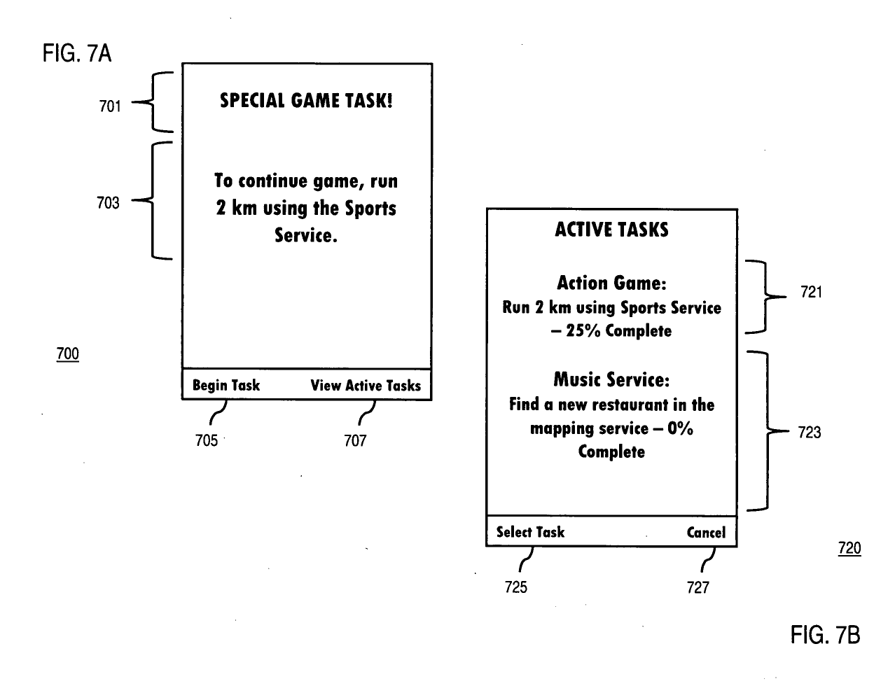

FIGS. 7A and 7B are diagrams of a user interface utilized in linked services, according to an exemplary embodiment. FIG. 7A depicts an example user interface 700 in which a user is presented with an alert 701 informing the user of a “Special Game Task!” as the user is engaged in a game under a gaming service. The alert 701 includes a task message 703 instructing the user that “To continue game, run 2 km using the Sports Service.” The user may select the option 705 to “Begin Task” which will direct the user to the sports service, or the user may select the option 707 to “View Active Tasks” which will direct the user to the an active status user interface 720 of FIG. 7B.

The active tasks user interface 620 lists the tasks that are currently available to the user and their corresponding status of completion. For example, the task 621 relates to a task assigned by a gaming service to run 2 km using the sports service. In this example, the linked services enabler 109 informs the user that the user has already completed 25% of the distance necessary to complete the task 621. The status information is provided, for instance, by the monitoring module 207 within the linked services enabler 109. The active tasks user interface 620 also includes a second task 623 to find a new restaurant using the mapping service. As shown, the user has yet to complete the task 623. The user may then highlight a task and select an option 625 to complete either task. On selection of the option 625, the linked services enabler 109 initiates the appropriate linked service 107 to allow the user to complete the task. The user may, for instance, select the option 627 to cancel and complete the tasks at another time.

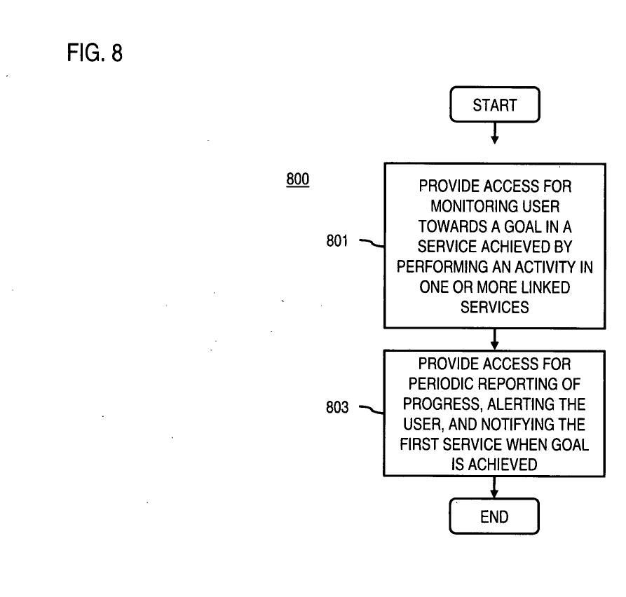

FIG. 8 is a flowchart of a process for monitoring user activity in linked services over a communication network, according to an exemplary embodiment. The described processes and arrangement advantageously, according to certain embodiments, provide for monitoring user activity in linked services 107a and 107b. In step 801, the communication network 105 provides access to the linked services enabler 109 within the terminals 101 and/or the services platform 103 for initiating monitoring of progress of a user towards achieving a goal corresponding to a service 107a and for periodic reporting of the progress, wherein the goal includes an activity to be completed in one or more linked services 107b-107n. In step 803, the communication network 105 also provides access for initiating reporting of the progress, alerting the user when the progress reaches a predetermined point or the activity is complete, and notifying the service 107a when the user completes the activity to achieve the goal. For example, providing access includes making network resources (e.g., bandwidth) available to the linked services enabler 109 to transport information related to the linked services 107a-107b, tasks related to the services 107a-107b, and progress related to performing the tasks. It is also contemplated that the communication network 105 can use any authentication mechanism (e.g., user ID/password, device ID filtering, etc.) to ensure that the linked services enabler 109 is authorized to transport data across the network 105.

The processes described herein for monitoring user activity in linked services may be implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

FIG. 9 illustrates a computer system 900 upon which an embodiment of the invention may be implemented. Computer system 900 is programmed to carry out the inventive functions described herein and includes a communication mechanism such as a bus 910 for passing information between other internal and external components of the computer system 900. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range.

A bus 910 includes one or more parallel conductors of information so that information is transferred quickly among devices coupled to the bus 910. One or more processors 902 for processing information are coupled with the bus 910.

A processor 902 performs a set of operations on information. The set of operations include bringing information in from the bus 910 and placing information on the bus 910. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 902, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 900 also includes a memory 904 coupled to bus 910. The memory 904, such as a random access memory (RAM) or other dynamic storage device, stores information including processor instructions. Dynamic memory allows information stored therein to be changed by the computer system 900. RAM allows a unit of information stored at a location called a memory address to be stored and retrieved independently of information at neighboring addresses. The memory 904 is also used by the processor 902 to store temporary values during execution of processor instructions. The computer system 900 also includes a read only memory (ROM) 906 or other static storage device coupled to the bus 910 for storing static information, including instructions, that is not changed by the computer system 900. Some memory is composed of volatile storage that loses the information stored thereon when power is lost. Also coupled to bus 910 is a non-volatile (persistent) storage device 908, such as a magnetic disk, optical disk or flash card, for storing information, including instructions, that persists even when the computer system 900 is turned off or otherwise loses power.

Information, including instructions, is provided to the bus 910 for use by the processor from an external input device 912, such as a keyboard containing alphanumeric keys operated by a human user, or a sensor. A sensor detects conditions in its vicinity and transforms those detections into physical expression compatible with the measurable phenomenon used to represent information in computer system 900. Other external devices coupled to bus 910, used primarily for interacting with humans, include a display device 914, such as a cathode ray tube (CRT) or a liquid crystal display (LCD), or plasma screen or printer for presenting text or images, and a pointing device 916, such as a mouse or a trackball or cursor direction keys, or motion sensor, for controlling a position of a small cursor image presented on the display 914 and issuing commands associated with graphical elements presented on the display 914. In some embodiments, for example, in embodiments in which the computer system 900 performs all functions automatically without human input, one or more of external input device 912, display device 914 and pointing device 916 is omitted.

In the illustrated embodiment, special purpose hardware, such as an application specific integrated circuit (ASIC) 920, is coupled to bus 910. The special purpose hardware is configured to perform operations not performed by processor 902 quickly enough for special purposes. Examples of application specific ICs include graphics accelerator cards for generating images for display 914, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 900 also includes one or more instances of a communications interface 970 coupled to bus 910. Communication interface 970 provides a one-way or two-way communication coupling to a variety of external devices that operate with their own processors, such as printers, scanners and external disks. In general the coupling is with a network link 978 that is connected to a local network 980 to which a variety of external devices with their own processors are connected. For example, communication interface 970 may be a parallel port or a serial port or a universal serial bus (USB) port on a personal computer. In some embodiments, communications interface 970 is an integrated services digital network (ISDN) card or a digital subscriber line (DSL) card or a telephone modem that provides an information communication connection to a corresponding type of telephone line. In some embodiments, a communication interface 970 is a cable modem that converts signals on bus 910 into signals for a communication connection over a coaxial cable or into optical signals for a communication connection over a fiber optic cable. As another example, communications interface 970 may be a local area network (LAN) card to provide a data communication connection to a compatible LAN, such as Ethernet. Wireless links may also be implemented. For wireless links, the communications interface 970 sends or receives or both sends and receives electrical, acoustic or electromagnetic signals, including infrared and optical signals, that carry information streams, such as digital data. For example, in wireless handheld devices, such as mobile telephones like cell phones, the communications interface 970 includes a radio band electromagnetic transmitter and receiver called a radio transceiver.

The term computer-readable medium is used herein to refer to any medium that participates in providing information to processor 902, including instructions for execution. Such a medium may take many forms, including, but not limited to, non-volatile media, volatile media and transmission media. Non-volatile media include, for example, optical or magnetic disks, such as storage device 908. Volatile media include, for example, dynamic memory 904. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read.

FIG. 10 illustrates a chip set 1000 upon which an embodiment of the invention may be implemented. Chip set 1000 is programmed to carry out the inventive functions described herein and includes, for instance, the processor and memory components described with respect to FIG. 9 incorporated in one or more physical packages. By way of example, a physical package includes an arrangement of one or more materials, components, and/or wires on a structural assembly (e.g., a baseboard) to provide one or more characteristics such as physical strength, conservation of size, and/or limitation of electrical interaction.

In one embodiment, the chip set 1000 includes a communication mechanism such as a bus 1001 for passing information among the components of the chip set 1000. A processor 1003 has connectivity to the bus 1001 to execute instructions and process information stored in, for example, a memory 1005. The processor 1003 may include one or more processing cores with each core configured to perform independently. A multi-core processor enables multiprocessing within a single physical package. Examples of a multi-core processor include two, four, eight, or greater numbers of processing cores. Alternatively or in addition, the processor 1003 may include one or more microprocessors configured in tandem via the bus 1001 to enable independent execution of instructions, pipelining, and multithreading. The processor 1003 may also be accompanied with one or more specialized components to perform certain processing functions and tasks such as one or more digital signal processors (DSP) 1007, or one or more application-specific integrated circuits (ASIC) 1009. A DSP 1007 typically is configured to process real-word signals (e.g., sound) in real time independently of the processor 1003. Similarly, an ASIC 1009 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 1003 and accompanying components have connectivity to the memory 1005 via the bus 1001. The memory 1005 includes both dynamic memory (e.g., RAM, magnetic disk, writable optical disk, etc.) and static memory (e.g., ROM, CD-ROM, etc.) for storing executable instructions that when executed perform the inventive steps described herein. The memory 1005 also stores the data associated with or generated by the execution of the inventive steps.

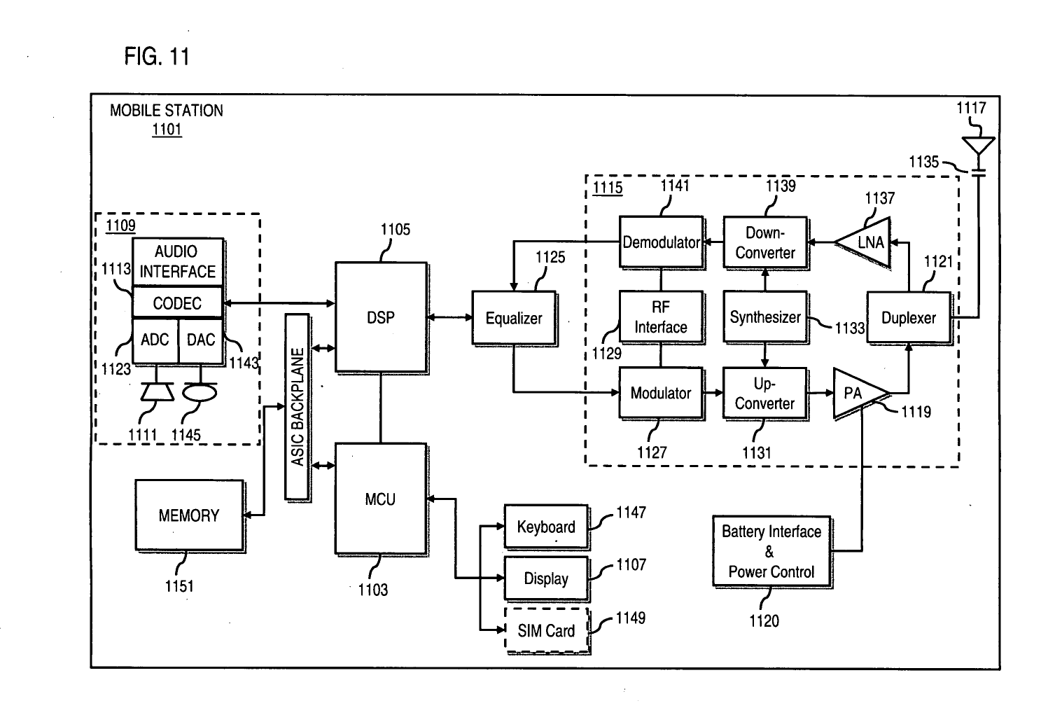

FIG. 11 is a diagram of exemplary components of a mobile station (e.g., handset) capable of operating in the system of FIG. 1, according to an exemplary embodiment. Generally, a radio receiver is often defined in terms of front-end and back-end characteristics. The front-end of the receiver encompasses all of the Radio Frequency (RF) circuitry whereas the back-end encompasses all of the base-band processing circuitry. Pertinent internal components of the telephone include a Main Control Unit (MCU) 1103, a Digital Signal Processor (DSP) 1105, and a receiver/transmitter unit including a microphone gain control unit and a speaker gain control unit. A main display unit 1107 provides a display to the user in support of various applications and mobile station functions. An audio function circuitry 1109 includes a microphone 1111 and microphone amplifier that amplifies the speech signal output from the microphone 1111. The amplified speech signal output from the microphone 1111 is fed to a coder/decoder (CODEC) 1113.

A radio section 1115 amplifies power and converts frequency in order to communicate with a base station, which is included in a mobile communication system, via antenna 1117. The power amplifier (PA) 1119 and the transmitter/modulation circuitry are operationally responsive to the MCU 1103, with an output from the PA 1119 coupled to the duplexer 1121 or circulator or antenna switch, as known in the art. The PA 1119 also couples to a battery interface and power control unit 1120.

In use, a user of mobile station 1101 speaks into the microphone 1111 and his or her voice along with any detected background noise is converted into an analog voltage. The analog voltage is then converted into a digital signal through the Analog to Digital Converter (ADC) 1123. The control unit 1103 routes the digital signal into the DSP 1105 for processing therein, such as speech encoding, channel encoding, encrypting, and interleaving. In the exemplary embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wireless fidelity (WiFi), satellite, and the like.

The encoded signals are then routed to an equalizer 1125 for compensation of any frequency-dependent impairments that occur during transmission though the air such as phase and amplitude distortion. After equalizing the bit stream, the modulator 1127 combines the signal with a RF signal generated in the RF interface 1129. The modulator 1127 generates a sine wave by way of frequency or phase modulation. In order to prepare the signal for transmission, an up-converter 1131 combines the sine wave output from the modulator 1127 with another sine wave generated by a synthesizer 1133 to achieve the desired frequency of transmission. The signal is then sent through a PA 1119 to increase the signal to an appropriate power level. In practical systems, the PA 1119 acts as a variable gain amplifier whose gain is controlled by the DSP 1105 from information received from a network base station. The signal is then filtered within the duplexer 1121 and optionally sent to an antenna coupler 1135 to match impedances to provide maximum power transfer. Finally, the signal is transmitted via antenna 1117 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile station 1101 are received via antenna 1117 and immediately amplified by a low noise amplifier (LNA) 1137. A down-converter 1139 lowers the carrier frequency while the demodulator 1141 strips away the RF leaving only a digital bit stream. The signal then goes through the equalizer 1125 and is processed by the DSP 1105. A Digital to Analog Converter (DAC) 1143 converts the signal and the resulting output is transmitted to the user through the speaker 1145, all under control of a Main Control Unit (MCU) 1103—which can be implemented as a Central Processing Unit (CPU) (not shown).

The MCU 1103 receives various signals including input signals from the keyboard 1147. The keyboard 1147 and/or the MCU 1103 in combination with other user input components (e.g., the microphone 111) comprise a user interface circuitry for managing user input. The MCU 1103 runs a user interface software to facilitate user control of at least some functions of the mobile station 1101. The MCU 1103 also delivers a display command and a switch command to the display 1107 and to the speech output switching controller, respectively. Further, the MCU 1103 exchanges information with the DSP 1105 and can access an optionally incorporated SIM card 1149 and a memory 1151. In addition, the MCU 1103 executes various control functions required of the station. The DSP 1105 may, depending upon the implementation, perform any of a variety of conventional digital processing functions on the voice signals. Additionally, DSP 1105 determines the background noise level of the local environment from the signals detected by microphone 1111 and sets the gain of microphone 1111 to a level selected to compensate for the natural tendency of the user of the mobile station 1101.

The CODEC 1113 includes the ADC 1123 and DAC 1143. The memory 1151 stores various data including call incoming tone data and is capable of storing other data including music data received via, e.g., the global Internet. The software module could reside in RAM memory, flash memory, registers, or any other form of writable storage medium known in the art. The memory device 1151 may be, but not limited to, a single memory, CD, DVD, ROM, RAM, EEPROM, optical storage, or any other non-volatile storage medium capable of storing digital data.

An optionally incorporated SIM card 1149 carries, for instance, important information, such as the cellular phone number, the carrier supplying service, subscription details, and security information. The SIM card 1149 serves primarily to identify the mobile station 1101 on a radio network. The card 1149 also contains a memory for storing a personal telephone number registry, text messages, and user specific mobile station settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising:
initiating monitoring of progress of a user towards achieving a goal corresponding to a service,
wherein the goal includes an activity to be completed in one or more linked services.

2. A method of claim 1, further comprising:
initiating periodic reporting of the progress; and
alerting the user when the progress reaches a predetermined point or the activity is completed.

3. A method of claim 1, wherein the one or more processors are caused to further perform:
notifying the service when the user completes the activity to achieve the goal.

4. A method of claim 1, wherein either the service or the one or more linked services includes a gaming service, a sports service, a mapping application, a media application, media content, a messaging application, or a combination thereof.

5. A method of claim 1, wherein the step of monitoring is performed through automated measurement, manual reporting by the user, manual reporting by an authenticated third-party reporter, or a combination thereof

6. A method of claim 5, wherein the automated measurement is performed using a physical measurement accessory to measure parameters including acceleration, movement, location, elevation, heart rate, orienteering support parameters, galvanic skin response, conductivity, body fat, body mass, body mass index, or a combination thereof.

7. A method of claim 1, wherein the service and the one or more linked services are individual components of a single service platform, and wherein a third party provides either the service or the one or more linked services.

8. An apparatus comprising:
at least one processor; and
at least one memory including computer program code,
the at least one memory and the computer program code configured to, with the at least one processor, cause the apparatus to perform at least the following,
initiate monitoring of progress of a user towards achieving a goal corresponding to a service,
wherein the goal includes an activity to be completed in one or more linked services.

9. An apparatus of claim 8, wherein the apparatus is further caused to:
initiate periodic reporting of the progress;
alert the user when the progress reaches a predetermined point or the activity is completed; and
notify the service when the user completes the activity to achieve the goal.

10. An apparatus of claim 8, wherein either the service or the one or more linked services includes a gaming service, a sports service, a mapping application, a media application, media content, a messaging application, or a combination thereof.

11. An apparatus of claim 8, wherein the step of monitoring is performed through automated measurement, manual reporting by the user, manual reporting by an authenticate third-party reporter, or a combination thereof.

12. An apparatus of claim 8, wherein the automated measurement is performed using a physical measurement accessory to measure parameters including acceleration, movement, location, elevation, heart rate, orienteering support parameters, galvanic skin response, conductivity, body fat, body mass, body mass index, or a combination thereof.

13. An apparatus of claim 8, wherein the service and the one or more linked services are individual components of a single service platform, and wherein a third party provides either the service or the one or more linked services.

14. An apparatus of claim 8, wherein the apparatus is a mobile phone further comprising:
user interface circuitry and user interface software configured to facilitate user control of at least some functions of the mobile phone through use of a display and configured to respond to user input; and
a display and display circuitry configured to display at least a portion of a user interface of the mobile phone, the display and display circuitry configured to facilitate user control of at least some functions of the mobile phone.

15. An apparatus of claim 13, wherein the mobile phone downloads the service, the one or more linked services, or a combination thereof over a wireless communication network.

16. A computer-readable storage medium carrying one or more sequences of one or more instructions which, when executed by one or more processors, cause an apparatus to perform at least the following:
initiating monitoring of progress of a user towards achieving a goal corresponding to a service,
wherein the goal includes an activity to be completed in one or more linked services.

17. A computer-readable storage medium of claim 16, wherein the step of monitoring is performed through automated measurement, manual reporting by the user, manual reporting by an authenticate third-party reporter, or a combination thereof, and wherein either the service or the one or more linked services includes a game, sports service, mapping application, media application, media content, messaging application, or a combination thereof.

18. A method comprising:
providing access for initiating monitoring of progress of a user towards achieving a goal corresponding to a service and for periodic reporting of the progress, wherein the goal includes an activity to be completed in one or more linked services.

19. A method of claim 18, further comprising:
providing access for initiating period reporting of the progress, alerting the user when the progress reaches a predetermined point or the activity is complete, and notifying the service when the user completes the activity to achieve the goal.

20. A method of claim 19, wherein the step of monitoring is performed through automated measurement, manual reporting by the user, manual reporting by an authenticate third-party reporter, or a combination thereof, and wherein either the first service or the second service includes a game, sports service, mapping application, media application, media content, messaging application, or a combination thereof.
